(19) United States
(12) Patent Application Publication
(10) Pub. No.: US 2018/0346789 A1
(43) Pub. Date: Dec. 6, 2018

(54) COMPOSITIONS AND METHODS FOR CLEANING A WELLBORE

(71) Applicant: SCHLUMBERGER TECHNOLOGY CORPORATION, Sugar Land, TX (US)

(72) Inventors: Syed Afaq ALI, Sugar Land, TX (US); Samuel DANICAN, Sugar Land, TX (US); Stephen DAVIES, Suga Land, TX (US)

(21) Appl. No.: 15/775,516

(22) PCT Filed: Nov. 10, 2016
(86) PCT No.: PCT/US2016/061215

§ 371 Date: May 11, 2018

Related U.S. Application Data
(60) Provisional application No. 62/254,471, filed on Nov. 12, 2015.

(51) Int. Cl. C09K 8/52

(52) U.S. Cl. CPC C09K 8/52; C09K 2208/32

(57) ABSTRACT

Disclosed herein are wellbore-cleaning compositions, and methods of using such in cleaning wellbores, including a solvent, a co-solvent, an anionic surfactant mixture comprising a first anionic surfactant and a second anionic surfactant, a non-ionic surfactant mixture comprising a first non-ionic surfactant, and a second non-ionic surfactant, and an aqueous fluid, wherein the wellbore-cleaning composition is in a single liquid phase.

### CROSS-REFERENCE TO RELATED APPLICATION

The present document is based on and claims priority to U.S. Provisional Application Ser. No. 62/254,471, filed Nov. 12, 2015, which is incorporated herein by reference in its entirety.

### BACKGROUND

This disclosure relates generally to compositions and methods for treating a subterranean well. More specifically, the present disclosure relates to compositions and methods for cleaning casing and wellbore surfaces with single liquid phase fluids.

Some statements may merely provide background information related to the present disclosure and may not constitute prior art.

The use of oil or synthetic-based drilling fluid (SBM/OBM) is widespread in many areas for a variety of reasons, including excellent shale inhibition, high rates of penetration and high lubricity. Oil- or synthetic-based drilling fluids generally comprise invert emulsion fluids, where the continuous or external phase is predominantly organic (e.g., mineral oil or synthetic oil), and the inverse or internal phase is usually aqueous (e.g., brines). The stability of invert emulsions is generally maintained by one or more additives present in the fluid, such as emulsifiers, emulsion stabilizing agents, and oil-wetting agents.

When drilling is performed with SBM/OBM fluids, the wellbore becomes oil-wet. Wells with openhole completions have no casing or liner set across the productive interval. They are common in today's horizontal and highly deviated wells, where operations for running casing, cementing, and perforating may not be technically or commercially feasible. Horizontal wells are increasingly being used around the world in an attempt to increase production rates by maximizing reservoir exposure and targeting multiple zones. SBM/OBM fluids are often used to drill the productive intervals in these wells. These reservoir drilling fluids are designed to form low permeability filtercakes that prevent or reduce excessive fluid leakoff into the formation during drilling. In openhole completions, there are usually no perforations or hydraulic fractures to bypass the filtercake damage. Inadequate removal of filtercake can severely impair well productivity or injectivity. Thus, a cleanup treatment to OBM/SBM filter cake is needed to minimize skin and formation damage and increase production flow area.

When the wellbore is to be cased and cemented, prior to cementing, the casing also becomes oil-wet while being run into the hole. This condition commonly results in poor bonding between the set cement and the casing and wellbore surfaces. Poor cement bonding may compromise the hydraulic seal in the annulus, potentially resulting in fluid communication between subterranean zones and potentially loss of the well integrity. Therefore, to ensure successful cementing, two conditions are necessary: (1) the SBM/OBM is effectively displaced and/or removed from the borehole; and (2) the wellbore-wall and casing surfaces are water-wet. Failure to satisfy Condition 1 may cause contamination of the cement slurry, and the cement performance may suffer. Failure to satisfy Condition 2 may lead to poor bonding between the cement and the borehole-wall and casing surfaces.

Despite efforts to prepare the borehole properly prior to cementing for cased and cemented completions, Cement Bond Logs (CBL) commonly reveal poor or no bonding, or poor-quality cement behind casing. Thus, there is always a need in the industry to provide improved fluids and systems for removing SBM and OBM fluids from a wellbore, cased or openhole.

### SUMMARY

Embodiments disclosed herein include methods to formulate a treatment composition that breaks the mud's interfacial rheological properties, act as a demulsifier to break the invert emulsion, and break the filter cake's bond with the wellbore wall. The fluid composition provides the ability to clean up filter cake, and to remove it completely, without causing additional formation damage.

Embodiments disclosed herein relate to wellbore treatment composition formulated for removing and dispersing OBM/SBM filter cakes. The composition is a miscible, synergistic blend of surfactants, solvent, and co-solvent. Each component in the treatment composition(s) plays a unique role in the efficacy of this composition in completely removing the OBM/SBM filter cakes.

In embodiments, disclosed are wellbore-cleaning compositions, including a solvent, a co-solvent, an anionic surfactant mixture comprising a first anionic surfactant and a second anionic surfactant, a non-ionic surfactant mixture comprising a first non-ionic surfactant, and a second non-ionic surfactant, and an aqueous fluid, wherein the wellbore-cleaning composition is in a single liquid phase.

In embodiments, disclosed are methods to treat formation damage or other service induced damage in a near wellbore region, or damage to the formation adjacent to the near wellbore, or both, of a wellbore, including: pumping a wellbore-cleaning composition into the wellbore, the wellbore-cleaning composition including a solvent, a co-solvent, an anionic surfactant mixture including a first anionic surfactant and a second anionic surfactant, a non-ionic surfactant mixture including a first non-ionic surfactant, and a second non-ionic surfactant, and an aqueous fluid, wherein the wellbore-cleaning composition is in a single liquid phase; and at least partially removing filter cake or damage from a zone of the near wellbore region or filter cake or damage to the formation adjacent to the near wellbore region, or both.

### BRIEF DESCRIPTION OF THE DRAWINGS

FIG. 1A shows a top view of an Oil-based mud filtercake built on top of a ceramic disc used in Examples 1 and 2.

FIG. 1B shows a 45° angle view of the Oil-based mud filtercake built on top of a ceramic disc of FIG. 1A.

FIG. 1C shows a side view of the Oil-based mud filtercake built on top of a ceramic disc of FIG. 1A.

FIG. 2A shows the breaker fluid before the test in Example 1.

FIG. 2B shows a top view of the test cell after breaker fluid removal in Example 1.

FIG. 2C shows the breaker fluid following the test in Example 1.

FIG. 2D shows a top view of the ceramic disc following the test in Example 1.

FIG. 3A shows the breaker fluid following the test in Example 2.

FIG. 3B shows a top view of the ceramic disc following the test in Example 2.

FIG. 4 shows formulations 1-7 of Example 3 after being aged for 24 hours at 250 degF.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the embodiments and should not be construed as a limitation to the scope and applicability of the disclosed embodiments. While the compositions of the present disclosure are described herein as comprising certain materials, it should be understood that the composition could optionally comprise two or more chemically different materials. In addition, the composition can also comprise some components other than the ones already cited.

In the summary and the description, each numerical value should be read once as modified by the term “about” (unless already expressly so modified), and then read again as not so modified unless otherwise indicated in context. Also, in the summary and the detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the Applicants appreciate and understand that any and all data points within the range are to be considered to have been specified, and that the Applicants have disclosed and enabled the entire range and all points within the range.

In an aspect, embodiments relate to a wellbore-cleaning composition comprising a single liquid phase. The composition may be introduced into the wellbore to remove and displace synthetic-base and/or oil-base drilling fluid, and, when the wellbore is to be cased, provide clean and water-wet casing and borehole surfaces prior to cementing. The filter cake or damage is caused by the use of synthetic-based drilling fluids or oil-based drilling fluids in the wellbore. The wellbore-cleaning composition is formed by combining a solvent, a co-solvent, an anionic surfactant mixture comprising a first anionic surfactant and a second anionic surfactant, a non-ionic surfactant mixture comprising a first non-ionic surfactant, and a second non-ionic surfactant, and an aqueous fluid, wherein the wellbore-cleaning composition is in a single liquid phase. Certain of the components of the wellbore-cleaning composition can be referred to as a group as a solvent/surfactant mixture, those components being: the solvent, the anionic surfactant mixture and the non-ionic surfactant mixture, each as described above. The solvent/surfactant mixture concentration in the wellbore-cleaning composition may be between about 1 and about 60 or between about 5 and about 50 or between about 10 and about 40 or between about 10 and about 30 or between about 10 and about 20% by weight, and the concentrations of the components of the solvent/surfactant mixture can be at the concentrations set out below.

The solvent may be ethylene glycol monobutyl ether, and is used as a mutual solvent or hydrotrope in the wellbore-cleaning composition. The solvent solubilizes the base-oil fraction of the filter cake and stabilizes the wellbore-cleaning composition in brines. The co-solvent (which serves as a stabilizer) comprises a glycol ether selected from the group consisting of diethylene glycol monomethyl ether, diethylene glycol monoethyl ether, triethylene glycol monomethyl ether, triethylene glycol monoethyl ether polyalkylene glycols. The cosolvent can act as a fluid stabilizer and prevents phase separation when the wellbore-cleaning composition is mixed with brines, especially at higher temperatures (in excess of: 150 or 180 or 200 or 250° F.). The solvent concentration in the wellbore-cleaning composition may be between about 0.4 and about 24 or between about 2 and about 20 or between about 4 and about 16 or between about 4 and about 12% by weight. The co-solvent concentration in the wellbore-cleaning composition may be between about 1 and about 30 or between about 1 and about 20 or between about 1 and about 10 or between about 4 and about 8% by weight. At conditions where the solvent/surfactant mixture is present in the wellbore-cleaning composition between about 10 and about 30% by weight, and the wellbore-cleaning composition is to be used at a temperature in the range of from about 200 and about 300° F., the co-solvent concentration in the wellbore-cleaning composition may be between about 4 and about 8% by weight.

The first non-ionic surfactant can comprise an alcohol alkoxylate, and the second non-ionic surfactant can comprise an alkylpolyglycoside. The alkylpolyglycosides can have alkyl groups with carbon-chain lengths from about 8 and 10. The alcohol alkoxylate can be selected from the group consisting of C9-C11 ethoxylated alcohols, polyethylene-polypropylene glycol mono (2ethylhexyl) ether, and combinations thereof. These first and second non-ionic surfactants act to increase the mobility of the wellbore-cleaning composition throughout the oil-based materials of the wellbore, aiding in the solubilizing of the filter cake and, water wetting the solids contained therein and the formation face. The first non-ionic surfactant concentration in the wellbore-cleaning composition may be between about 0.1 and about 7 or between about 0.6 and about 6 or between about 1 and about 5 or between about 1 and about 4% by weight. The second non-ionic surfactant concentration in the wellbore-cleaning composition may be between about 0.1 and about 6 or between about 0.5 and about 5 or between about 1 and about 4 or between about 1 and about 3% by weight.

The first anionic surfactant can comprise an alkylbenzene sulfonate and the second anionic surfactant can comprise an alkyl sulfosuccinate. The alkylbenzene sulfonate can be sodium dodecylbenzene sulfonate, and the alkyl sulfosuccinate can be dioctyl sodium sulfosuccinate. The first anionic surfactant helps the wellbore-cleaning composition obtain a complete breaking of the emulsion inside the filter cake and aids in disruption of the cake cohesion. The second anionic surfactant can serve to disperse solids (bridging agents and drill solids) upon in-situ break-up of the emulsion inside the filter cake. The first anionic surfactant concentration in the wellbore-cleaning composition may be between about 0.3 and about 18 or between about 1.5 and about 15 or between about 3 and about 12 or between about 3 and about 9% by weight. The second anionic surfactant concentration in the wellbore-cleaning composition may be between about 0.1 and about 6 or between about 0.5 and about 5 or between about 1 and about 4 or between about 1 and about 3% by weight.

The wellbore-cleaning composition can further comprise an acid or an acid generating compound. The acid can be an organic acid, such as acetic and formic acid, or an inorganic acid. The acid can dissolve the bridging solids such as calcium carbonates. A corrosion inhibitor may be included if acid is included in the formulation.

Some embodiments may include a delayed acid source in the wellbore-cleaning composition. The delayed acid source includes compounds which will release acid following a predetermined amount of time. In particular, compounds that hydrolyze to form acids in situ may be utilized as a delayed acid source. Such delayed acid sources may be provided, for example, by hydrolysis of an ester. Illustrative examples of such delayed acid sources include hydrolyzable anhydrides of carboxylic acids, hydrolyzable esters of carboxylic acids, hydrolyzable esters of phosphonic acid, hydrolyzable esters of sulfonic acid, hydrolyzable esters of lactic acid, and other similar hydrolyzable compounds.

Suitable esters may include carboxylic acid esters that achieve hydrolysis at a time that is predetermined based on the known downhole conditions, such as temperature and pH. The delayed acid source component may include a formic, acetic, or lactic acid ester of a C2-C30 alcohol, which may be mono- or polyhydric.

The aqueous fluid (serving as the base fluid) comprises water and can also be a brine solution. As used herein the base fluid is the fluid component that contains surfactant surfactants and solvent and co-solvent, and provides the wellbore treatment fluid its characteristic of being capable of completely removing the OBM/SPM filter cakes. Often the base fluid may be majority component of the fluidic portion of the wellbore treatment fluid.

The brine that may be used in the wellbore-cleaning composition may be natural or synthetic, with synthetic brine tending to more simple in constitution as compared to natural brines. The density of the wellbore-cleaning composition may be controlled by increasing the salt concentration in the brine. A brine may include halide salts of mono- or divalent cations of metals such as sodium, potassium, and calcium. The aqueous fluid concentration in the wellbore-cleaning composition may be between about 6 and about 80 or between about 15 and about 75 or between about 20 and about 75 or between about 30 and about 75 or between about 40 and about 70% by weight.

The wellbore-cleaning composition may be viscosified. Non-limiting examples of viscosifying agents suitable for use herein include aluminum phosphate ester, alkyl quarternary ammonium bentonite, alkyl quaternary ammonium montmorillonite, xanthan gum, gelatin, pectin, cellulosic derivatives, gum arabic, guar gum, locust bean gum, tara gum, cassia gum, agar, n-octenyl succinated starch, porous starch, alginates, carrageenates, chitosan, scleroglucan, diutan, welan gum and an organophilic clay such as CLAYTONE™ (available from Southern Clay Products, Inc.; Gonzalez, Tex., USA).

A trimer acid based rheology modifier such as RHEFLAT™ (available from M-I SWACO, Houston, Tex., USA) may be also added to the viscosified wellbore-cleaning composition to achieve a flat rheology profile. Without wishing to be bound by any theory, this compound is believed to enhance low-end viscosity and yield point by interacting with fine solids such as organophilic clay and weighting solids such as calcium carbonate, barite, and hematite. The rheology modifier may be present in an amount of from about 1 to about 5% by weight of the wellbore-cleaning composition.

The density of the wellbore-cleaning composition may also be adjusted by, for example, adding a suitable weighting agent or lightweight material. Suitable weighting agents include (but are not limited to) barite, an inorganic cement, calcium carbonate, hematite, ilmenite, magnesium tetraoxide and silica. Suitable lightweight materials include (but are not limited to) ceramic microspheres, glass microspheres, uintaite, uintahite, coal and nitrogen. It should be noted that weighting agents such as coarse barite, coarse calcium carbonate or coarse hematite may also be used as weighting agents in the present context. Inorganic cements comprise, but are not limited to, Portland cement, calcium aluminate cement, lime/silica blends, blast furnace slag, fly ash, Sorel cements, chemically bonded phosphate ceramics and geopolymers.

In a further aspect, embodiments relate to a method for cleaning a section of a wellbore for a wellbore intended for an openhole completion or a wellbore intended to be cased and cemented, prior to either openhole completion or a cementing operation, and having been treated with an oil- or synthetic-base drilling fluid. The method to treat formation damage or other service induced damage in a near wellbore region, or damage to the formation adjacent to the near wellbore, or both, of a wellbore, comprises pumping the wellbore-cleaning composition(s) as described herein into the wellbore; and at least partially removing filter cake or damage from a zone of the near wellbore region or filter cake or damage to the formation adjacent to the near wellbore region, or both, thereby providing clean and water-wet casing (for cased wellbores) and clean borehole surfaces in either openhole or cased wellbores. For cased surfaces, the clean surface will provide superior bonding of cement to the cleaned surfaces. The filter cake or damage can be caused by the use of synthetic-based drilling fluids or oil-based drilling fluids in the wellbore, as described herein.

The wellbore-cleaning compositions according to the present disclosure may be pumped alone, with a carrier fluid (which can be an aqueous brine), ahead of a conventional water-base spacer fluid or scavenger slurry and behind a conventional water-base spacer fluid or scavenger slurry. In this disclosure, scavenger slurries will be considered to be a type of spacer fluid. In addition, the disclosed wellbore-cleaning compositions are also effective when incorporated into a carrier fluid such as (but not limited to) a conventional water-base spacer fluid or scavenger slurry. When the disclosed composition is incorporated within the carrier fluid, the wellbore-cleaning composition concentration in the resulting fluid mixture may be between about 5 vol % and 20 vol %, or between about 10 vol % and 15 vol %, or between about 10 vol % and 12 vol %, based on the total weight of the combined fluid.

The wellbore-cleaning composition, the carrier fluid or both may be viscosified. Non-limiting examples of viscosifying agents suitable for use herein include aluminum phosphate ester, alkyl quarternary ammonium bentonite, alkyl quaternary ammonium montmorillonite, xanthan gum, gelatin, pectin, cellulosic derivatives, gum arabic, guar gum, locust bean gum, tara gum, cassia gum, agar, n-octenyl succinated starch, porous starch, alginates, carrageenates, chitosan, scleroglucan, diutan, welan gum and an organophilic clay such as CLAYTONE™ (available from Southern Clay Products, Inc.; Gonzalez, Tex., USA).

A trimer acid based rheology modifier such as RHEFLAT™ (available from M-I SWACO, Houston, Tex., USA) may be also added to the viscosified wellbore-cleaning composition to achieve a flat rheology profile. Without wishing to be bound by any theory, this compound is believed to enhance low-end viscosity and yield point by interacting with fine solids such as organophilic clay and weighting solids such as calcium carbonate, barite, and hematite. The rheology modifier may be present in an amount of from about 1 to about 5% by weight of the microemulsion.

The density of the wellbore-cleaning composition, the carrier fluid or both may also be adjusted by, for example, adding a suitable weighting agent or lightweight material. Suitable weighting agents include (but are not limited to) barite, an inorganic cement, calcium carbonate, hematite, ilmenite, magnesium tetraoxide and silica. Suitable lightweight materials include (but are not limited to) ceramic microspheres, glass microspheres, uintaite, uintahite, coal and nitrogen. It should be noted that weighting agents such as coarse barite, coarse calcium carbonate or coarse hematite may also be used as weighting agents in the present context. Inorganic cements comprise, but are not limited to, Portland cement, calcium aluminate cement, lime/silica blends, blast furnace slag, fly ash, Sorel cements, chemically bonded phosphate ceramics and geopolymers.

In yet a further aspect, embodiments relate to methods for cementing a subterranean well having a borehole. The wellbore has a casing suspended therein and contains, or has been treated with, an oil-base or synthetic-base drilling fluid. The method comprising (i) providing the disclosed wellbore-cleaning composition, (ii) pumping the composition into the region between the casing and the wellbore, (iii) providing a cement slurry, and (iv) pumping the cement slurry into the region between the casing and the wellbore. The wellbore-cleaning composition removes the drilling fluid from the region between the casing and the wellbore, thereby providing clean and water-wet casing and borehole surfaces.

### EXAMPLES

The following examples serve to illustrate the embodiments.

### First Mixture Preparation

A first mixture was formulated, comprising a mixture of solvents, surfactants and water as shown in Table 1.

TABLE 1

| Chemical Component | % by weight |
|---|---|
| DI water | 6.5 |
| Alkylpolyglycoside | 6.5 |
| C9-C11 Ethoxylated Alcohol | 7.8 |
| Polyethylene-polypropylene glycol | 3.9 |
| mono (2ethylhexyl) ether | |
| Ethylene Glycol Monobutyl Ether | 41.5 |
| Alkylbenzene sulfonate | 27.3 |
| Docusate sodium salt | 6.5 |
| Total Weight | 100.00 |

For the following examples, the first mixture was added to other components to form wellbore-cleaning compositions.

### Example 1

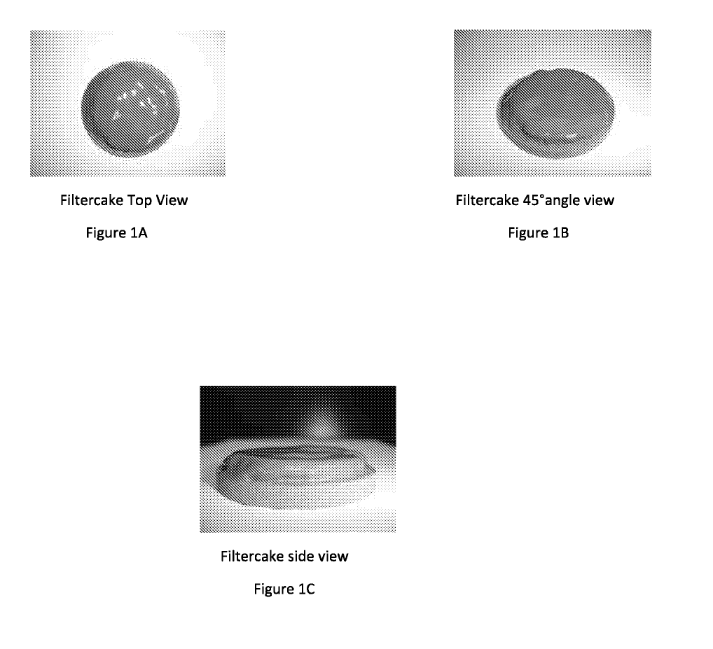

Oil-based mud filtercakes were built on top of a ceramic disc in a HPHT fluid loss cell. FIGS. 1A-1C show pictures of the filter cake as built on the disc.

Oil-based mud: Saudi origin
Ceramic disc: OFITE part No. 170-53-3 (pore throat=20 microns (Hg); Dimensions: 2.49″ D×0.25″)
Temperature: 150 degF for 20 hrs; Net pressure: 500 psi

The fluid loss cell was opened and the excess mud was carefully removed. Table 2 below shows the ingredients of Fluid A used in this Example 1. 200 mL of Fluid A was placed on top of the filter cake and the cell was then brought to temperature (250 degF) and pressure (200 psi net pressure). Fluid A was left to soak on the filter cake for 12 hrs at temperature and static conditions. After the cell cooled down, it was opened, the spent Fluid A was poured into a jar and the ceramic disc was carefully removed.

TABLE 2
Fluid A

| Component | % by Vol |
|---|---|
| 8.6 ppg Sodium Chloride Brine | 59.8 |
| First Mixture | 23.1 |
| Diethylene glycol monoethyl ether | 6.9 |
| Glacial acetic acid | 10 |
| Corrosion inhibitor | 0.2 |
| Total | 100.00 |

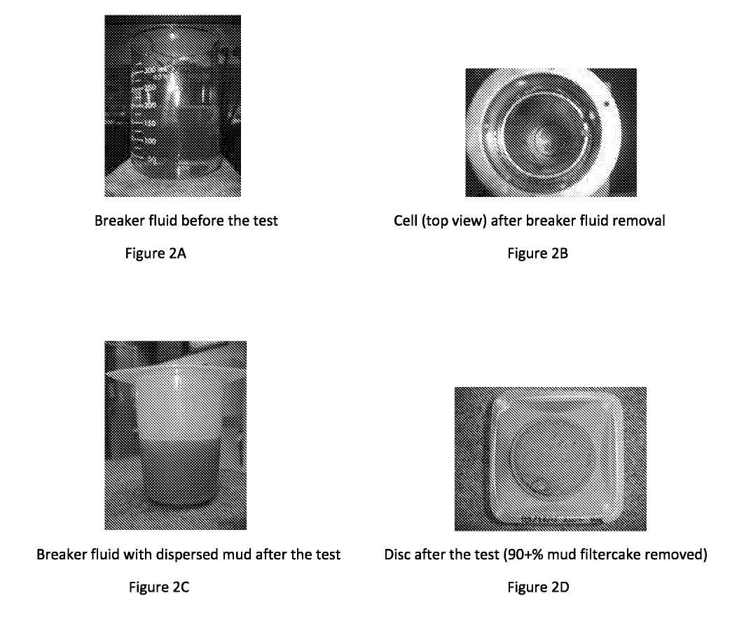

As can be seen from FIGS. 1A-1C, and 2A-2D, Fluid A was very effective in treating the built-up filter cake, removing 90+% of the mud filtercake.

### Example 2

Same conditions and procedure as Example 1 but with a different cleaning fluid—Fluid B (lower content of the first mixture) shown in Table 3 below.

TABLE 3
Fluid B

| Component | % by Vol |
|---|---|
| 8.6 ppg Sodium Chloride Brine | 69.8 |
| First Mixture | 15.4 |
| Diethylene glycol monoethyl ether | 4.6 |
| Glacial acetic acid | 10 |
| Corrosion inhibitor | 0.2 |
| Total | 100.00 |

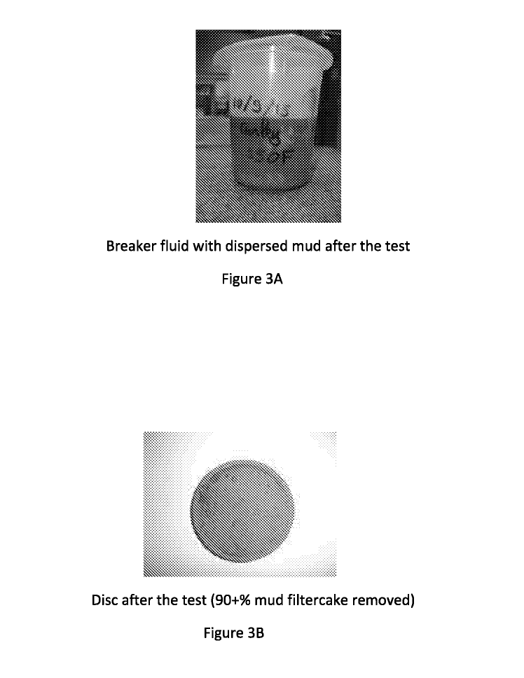

As can be seen from FIGS. 1A-1C, and 3A-3B, Fluid B was very effective in treating the built-up filter cake, removing 90+% of the mud filtercake.

### Example 3: Stability of Wellbore-Cleaning Formulations

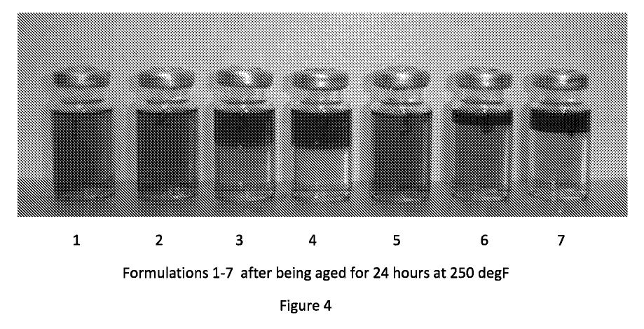

Seven wellbore-cleaning formulations 1-7, shown in Table 4 below, were aged for 24 hours at 250 degF in static conditions. This test shows, with reference to FIG. 4, that formulations 1, 2 and 5 having elevated concentrations of Diethylene glycol monoethyl ether (one of the cosolvent choices disclosed herein) showed much better stability and prevention of phase separation at a 250° F. temperature than formulations 3, 4, 6 and 7 which contained much less cosolvent.

TABLE 4

| | vol % | | | | | | |
|---|---|---|---|---|---|---|---|
| | #1 | #2 | #3 | #4 | #5 | #6 | #7 |
| 8.6 ppg NaCl brine | 59.8 | 59.8 | 59.8 | 59.8 | 69.8 | 69.8 | 69.8 |
| First Mixture | 23 | 25 | 27 | 29 | 15 | 17 | 19 |
| Diethylene glycol | 7 | 5 | 3 | 1 | 5 | 3 | 1 |
| monoethyl ether | | | | | | | |
| Glacial acetic acid | 10 | 10 | 10 | 10 | 10 | 10 | 10 |
| Corrosion inhibitor | 0.2 | 0.2 | 0.2 | 0.2 | 0.2 | 0.2 | 0.2 |

The foregoing disclosure and description is illustrative and explanatory, and it can be readily appreciated by those skilled in the art that various changes in the size, shape and materials, as well as in the details of the illustrated construction or combinations of the elements described herein can be made without departing from the spirit of the disclosure.

1. A wellbore-cleaning composition, comprising a solvent, a co-solvent, an anionic surfactant mixture comprising a first anionic surfactant and a second anionic surfactant, a non-ionic surfactant mixture comprising a first non-ionic surfactant, and a second non-ionic surfactant, and an aqueous fluid, wherein the wellbore-cleaning composition is in a single liquid phase.

2. The composition of claim 1, wherein the solvent comprises ethylene glycol monobutyl ether.

3. The composition of claim 1, wherein the co-solvent comprises a glycol ether selected from the group consisting of diethylene glycol monomethyl ether, diethylene glycol monoethyl ether, triethylene glycol monomethyl ether, triethylene glycol monoethyl ether.

4. The composition of claim 1, wherein the first non-ionic surfactant comprises an alcohol alkoxylate, and the second non-ionic surfactant comprises an alkylpolyglycoside.

5. The composition of claim 4, wherein the alcohol alkoxylate is selected from the group consisting of C9-C11 ethoxylated alcohols, polyethylene-polypropylene glycol mono (2ethylhexyl) ether, and combinations thereof.

6. The composition of claim 1, wherein the first anionic surfactant comprises an alkylbenzene sulfonate and the second anionic surfactant comprises an alkyl sulfosuccinate.

7. The composition of claim 6, wherein the alkylbenzene sulfonate is sodium dodecylbenzene sulfonate, and the alkyl sulfosuccinate is dioctyl sodium sulfosuccinate.

8. The composition of claim 1, wherein the wellbore-cleaning composition further comprises an acid or an acid generating compound.

9. The composition of claim 1, wherein the wellbore-cleaning composition comprises:
0.4%-24% by weight of the solvent
1%-30% by weight of the co-solvent;
0.3%-18% by weight of the first anionic surfactant;
0.1%-6% by weight of the second anionic surfactant;
0.1%-7% by weight of the first non-ionic surfactant;
0.1%-6% by weight of the second non-ionic surfactant; and
6%-80% by weight aqueous fluid.

10. A method to treat formation damage or other service induced damage in a near wellbore region, or damage to the formation adjacent to the near wellbore, or both, of a wellbore, comprising:
pumping a wellbore-cleaning composition into the wellbore, the wellbore-cleaning composition comprising a solvent, a co-solvent, an anionic surfactant mixture comprising a first anionic surfactant and a second anionic surfactant, a non-ionic surfactant mixture comprising a first non-ionic surfactant, and a second non-ionic surfactant, and an aqueous fluid, wherein the wellbore-cleaning composition is in a single liquid phase; and
at least partially removing filter cake or damage from a zone of the near wellbore region or filter cake or damage to the formation adjacent to the near wellbore region, or both.

11. The method of claim 10, wherein the solvent comprises ethylene glycol monobutyl ether.

12. The method of claim 10, wherein the co-solvent comprises a glycol ether selected from the group consisting of diethylene glycol monomethyl ether, diethylene glycol monoethyl ether, triethylene glycol monomethyl ether, triethylene glycol monoethyl ether.

13. The method of claim 10, wherein the first non-ionic surfactant comprises an alcohol alkoxylate, and the second non-ionic surfactant comprises an alkylpolyglycoside.

14. The method of claim 10, wherein the first anionic surfactant comprises an alkylbenzene sulfonate and the second anionic surfactant comprises an alkyl sulfosuccinate.

15. The method of claim 10, wherein the wellbore-cleaning composition further comprises an acid or an acid generating compound.

16. The method of claim 10, wherein the wellbore-cleaning composition comprises:
0.4%-24% by weight of the solvent
1%-30% by weight of the co-solvent;
0.3%-18% by weight of the first anionic surfactant;
0.1%-6% by weight of the second anionic surfactant;
0.1%-7% by weight of the first non-ionic surfactant;
0.1%-6% by weight of the second non-ionic surfactant; and
6%-80% by weight aqueous fluid.

17. The method of claim 10, wherein the wellbore-cleaning composition further comprises a viscosifying agent that comprises one or more members of the group comprising: aluminum phosphate ester, bentonite, alkyl quarternary ammonium bentonite, alkyl quaternary ammonium montmorillonite, an inorganic cement, xanthan gum, gelatin, pectin, cellulosic derivatives, gum arabic, guar gum, locust bean gum, tara gum, cassia gum, agar, n-octenyl succinated starch, porous starch, alginates, carrageenates, chitosan, scleroglucan, diutan, welan gum and an organophilic clay.

18. The method of claim 10, wherein the wellbore-cleaning composition is pumped into the wellbore by itself or diluted in water, ahead of a conventional spacer fluid or scavenger slurry, behind a conventional spacer fluid or scavenger slurry, or is incorporated into a carrier fluid and pumped within the resulting mixture.

19. The method of claim 18, wherein the carrier fluid comprises an aqueous fluid and a viscosifying agent comprising one or more members of the group comprising: aluminum phosphate ester, bentonite, alkyl quarternary ammonium bentonite, alkyl quaternary ammonium montmorillonite, an inorganic cement, xanthan gum, gelatin, pectin, cellulosic derivatives, gum arabic, guar gum, locust bean gum, tara gum, cassia gum, agar, n-octenyl succinated starch, porous starch, alginates, carrageenates, chitosan, scleroglucan, diutan, welan gum and an organophilic clay.

20. The method of claim 10 wherein the filter cake or damage is caused by the use of synthetic-based drilling fluids or oil-based drilling fluids in the wellbore.
